(19) United States
(12) Patent Application Publication
(10) Pub. No.: US 2011/0240571 A1
(43) Pub. Date: Oct. 6, 2011

(54) Modular utility rack

(76) Inventor: Edwin Ho, Irvine, CA (US)

(21) Appl. No.: 13/066,140

(22) Filed: Apr. 7, 2011

Related U.S. Application Data
(63) Continuation-in-part of application No. 12/804,857, filed on Jul. 30, 2010.
Application No. 12/804,857 is a continuation-in-part of application No. 29/315,014, filed on May 18, 2009, now Pat. No. D626356.
Application No. 29/315,014 is a division of application No. 29/312,973, filed on Nov. 26, 2008, now Pat. No. D602712.

(51) Int. Cl. A47B 96/02; B23P 19/00

(52) U.S. Cl. 211/13.1; 29/426.1

(57) ABSTRACT

A rack has a frame and at least one shelf. The frame has a first rear support member and a second rear support member, with each support member having a left side and a right side, with the right side of the first rear support member pivotably connected to the left side of the second rear support member. The frame further includes a left support that is pivotably connected to the left side of the first rear support member and a right support that is pivotably connected to the right side of the second rear support member. The shelf has a left side and a right side, with a first hooked connector provided on the left side of the shelf and a second hooked connector provided on the right side of the shelf. The first hooked connector removably connects the left side of the shelf to a horizontal bar on the left support, and the second hooked connector removably connects the right side of the shelf to a horizontal bar on the right support.

### 1. RELATED CASES

This is a continuation-in-part of co-pending Ser. No. 12/804,857, filed Jul. 30, 2010, which is a continuation-in-part of Ser. No. 29/315,014, filed May 18, 2009, now U.S. D626,356, which is a divisional of Ser. No. 29/312,973, filed Nov. 26, 2008, now U.S. D602,712, whose disclosures are incorporated by this reference as though set forth fully herein.

### BACKGROUND OF THE INVENTION

2. Field of the Invention

The present invention relates to a modular utility rack for placing common household articles, and in particular, to a rack for holding articles.

3. Description of the Prior Art

Article-holding racks are used by people in their daily lives to hold common household articles such as towels, clothes, shoes, etc. Many of these racks can be folded or dis-assembled to reduce that overall size and profile for storage and transportation. Unfortunately, many of these conventional racks are still difficult to fold, or assemble and disassemble, so that storage and transport can be inconvenient. In this regard, the construction of many of these racks is rather complex, leading to increased costs of production or inconvenience to the user.

### SUMMARY OF THE INVENTION

The present invention provides a rack that has a frame and at least one shelf. The frame has a first rear support member and a second rear support member, with each support member having a left side and a right side, with the right side of the first rear support member pivotably connected to the left side of the second rear support member. The frame further includes a left support that is pivotably connected to the left side of the first rear support member and a right support that is pivotably connected to the right side of the second rear support member. The shelf has a left side and a right side, with a first hooked connector provided on the left side of the shelf and a second hooked connector provided on the right side of the shelf. The first hooked connector removably connects the left side of the shelf to a horizontal bar on the left support, and the second hooked connector removably connects the right side of the shelf to a horizontal bar on the right support.

### BRIEF DESCRIPTION OF THE DRAWINGS

FIG. 1 is a perspective view of a rack according to one embodiment of the present invention.

FIG. 2 is a front plan view of the rack of FIG. 1.

FIG. 3 is a left plan view of the rack of FIG. 1.

FIG. 4 is a right plan view of the rack of FIG. 1.

FIG. 5 is a top plan view of the rack of FIG. 1.

FIG. 6 is a bottom plan view of the rack of FIG. 1.

FIG. 7 is a rear plan view of the rack of FIG. 1.

FIG. 8 is a perspective view of a rack according to another embodiment of the present invention.

FIG. 9 is a front plan view of the rack of FIG. 8.

FIG. 10 is a left plan view of the rack of FIG. 8.

FIG. 11 is a right plan view of the rack of FIG. 8.

FIG. 12 is a top plan view of the rack of FIG. 8.

FIG. 13 is a bottom plan view of the rack of FIG. 8.

FIG. 14 is a rear plan view of the rack of FIG. 8.

FIG. 15 is a perspective view of a rack according to yet another embodiment of the present invention.

FIG. 16 illustrates how the rack of FIG. 15 can be folded up.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

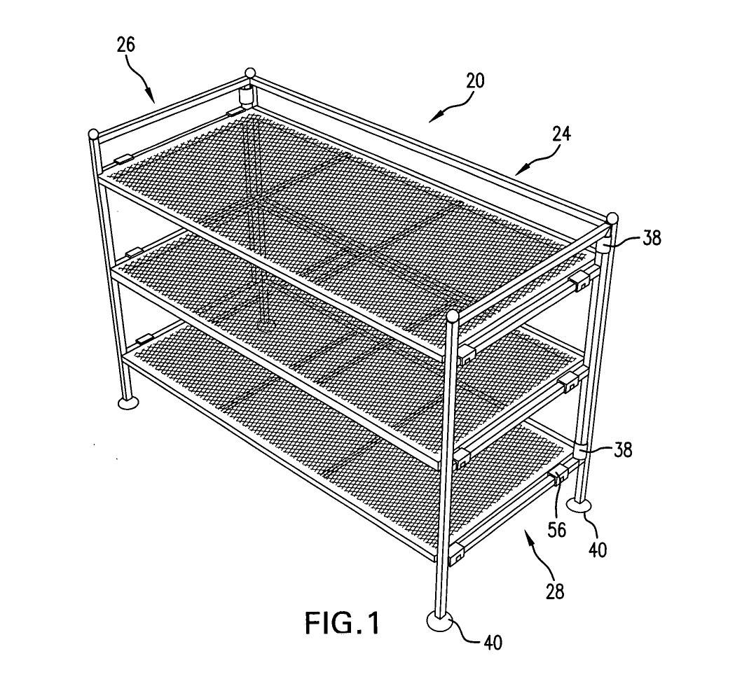

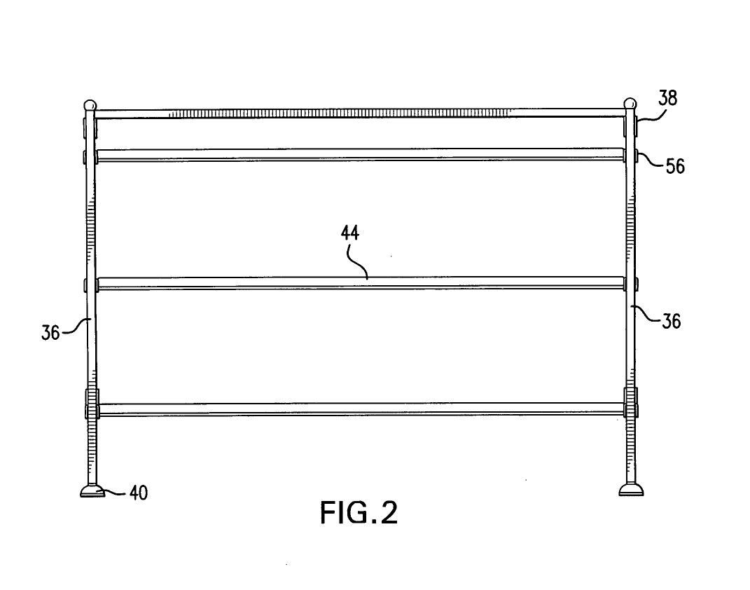

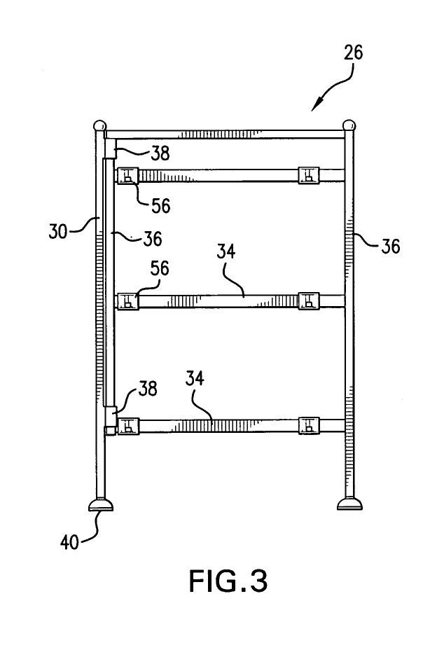

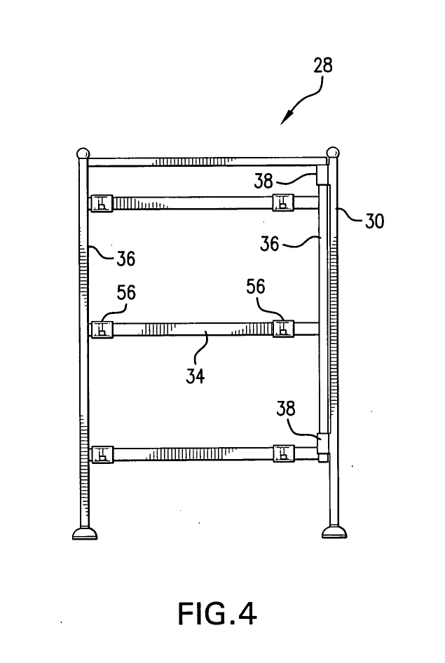

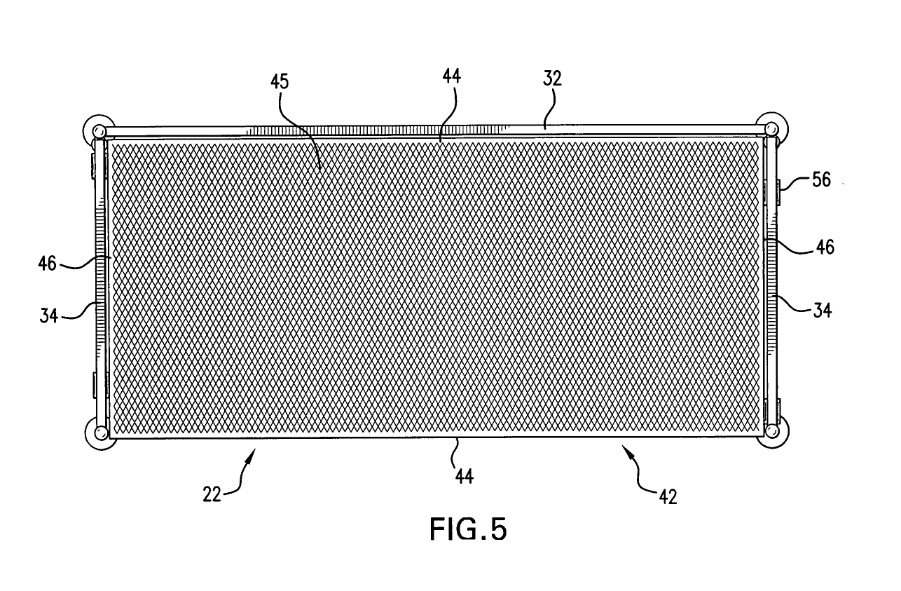

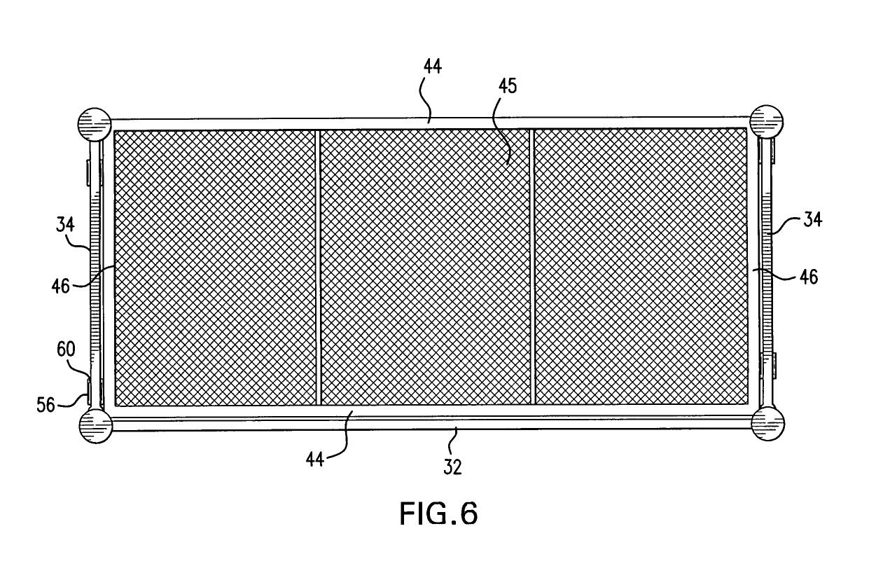

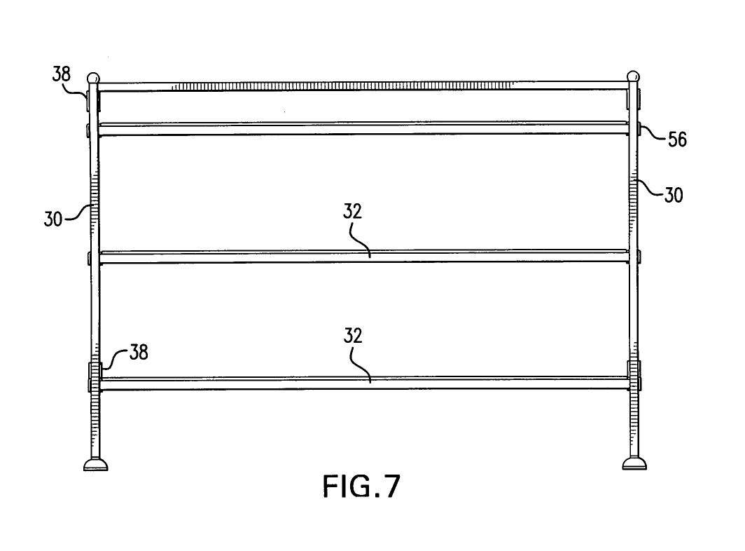

FIGS. 1-7 illustrate a rack according to one embodiment of the present invention. The rack has a foldable frame 20 and a plurality of removable shelves 22. The frame 20 and the shelves 22 can be made from one of a variety of materials, including a plastic, steel, a type of resin, wood or bamboo.

The frame 20 has a rear support 24, a left support 26 and a right support 28. The rear support 24 has two vertical bars 30 and a plurality of horizontal bars 32 extending between the vertical bars 30. Similarly, the left and right supports 26 and 28 have a plurality of horizontal bars 34 extending between two vertical bars 36. The horizontal bars 32 and 34 are aligned at the same level because the horizontal bars 32, 34 at the same level function to attach a shelf 22. Collars 38 are provided to pivotably connect the vertical bars 30 of the rear support 24 to a corresponding vertical bar 36 of the left support 26 or the right support 28. The vertical bars 30, 36 are received inside the collar 38 so that the supports 24+26 or 24+28 can pivot thereabout. As a result, the left support 26 and the right support 28 can be pivoted or folded towards each other to rest against the rear support 24 when the rack is disassembled and packaged for storage or transportation. Feet 40 can be provided at the bottom of the vertical bars 30, 36.

Each shelf 22 can have the same construction, and be coupled to the supports 26, 28 in the same manner. The shelf 22 has an enclosing frame member 42 that is generally rectangular in configuration, having two long sides 44 connected by two short sides 46. These sides 44 and 46 can be provided in the form of metal bars or metal sheets. The long sides 44 represent the front and rear sides, while the short sides 44 represent the left and right sides. A mesh 45 (e.g., metal or plastic) spans the internal space defined by the sides 44, 46.

In addition, a plurality of hooked connectors 56 can be secured to the exterior surfaces of the short sides 46. Each connector 56 has an inverted U-shape which defines two side walls and a top wall that define a receiving space. A lining 60 can be snap-fitted into the space of each connector 56. Each lining 60 also defines a receiving space. To secure the shelf 22 to the left and right supports 26, 28, the shelf 22 can be maneuvered at an angle between horizontal bars 32 of the rear support 24 and horizontal bars 34 of the left and right supports 26, 28, and then all the linings 60 on one short side 46 of the shelf 22 are clipped on to a horizontal bar 34 of the left support 26, and all the linings 60 on the opposite short side 46 of the shelf 22 are clipped on to a horizontal bar 34 of the right support 28 that is aligned at the same level as the horizontal bar 34 of the left support 26. The horizontal bar 34 is received in the receiving space of the lining 60. The lining 60 has the same configuration as (but is slightly smaller than) the connector 56, is made of a plastic or resin material, and functions to secure the shelf 22 to the horizontal bars 34. The lining 60 can be omitted if desired, in which case the connector 56 can be snapped directly on to the horizontal bar 34.

To disassemble the rack, the user lifts up each shelf 22, thereby disengaging the connectors 56 (and their linings 60) from the horizontal bars 34, to remove each shelf 22. The left and right supports 26, 28 are then folded against the rear support 24, and the shelves 22 stacked on top of the folded frame 20, to form a stack of frame 20 and shelves 22 that can be quickly and conveniently packed into a box or otherwise tied together via straps for storage and/or transportation.

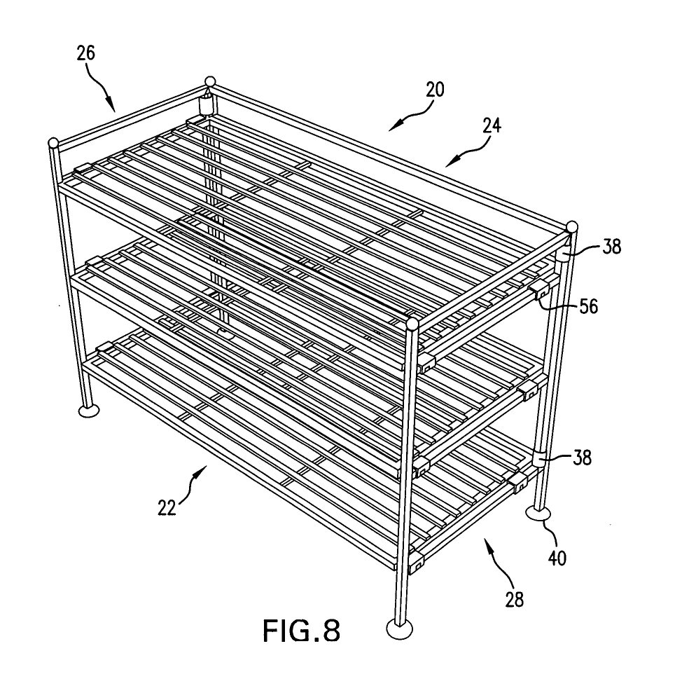

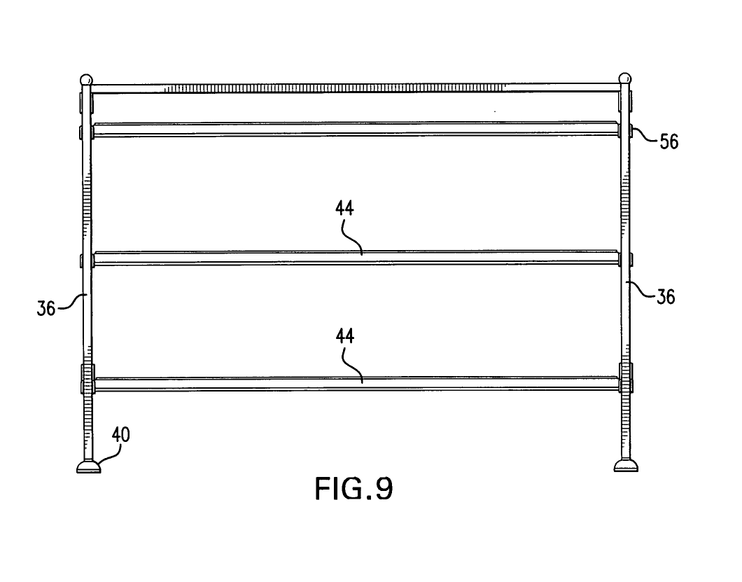

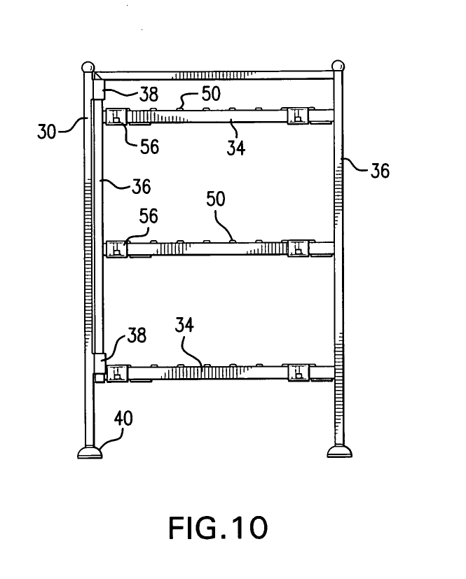

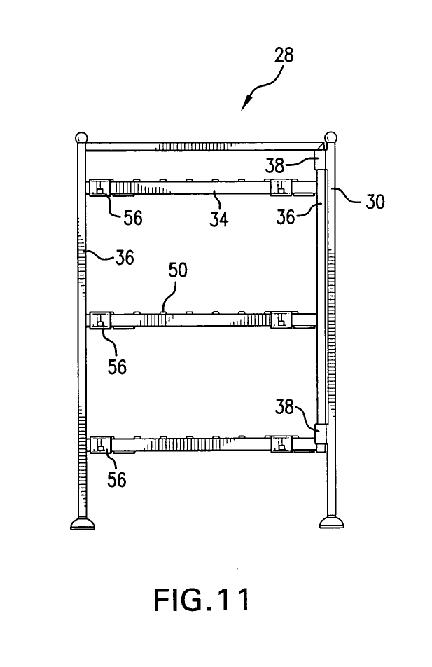

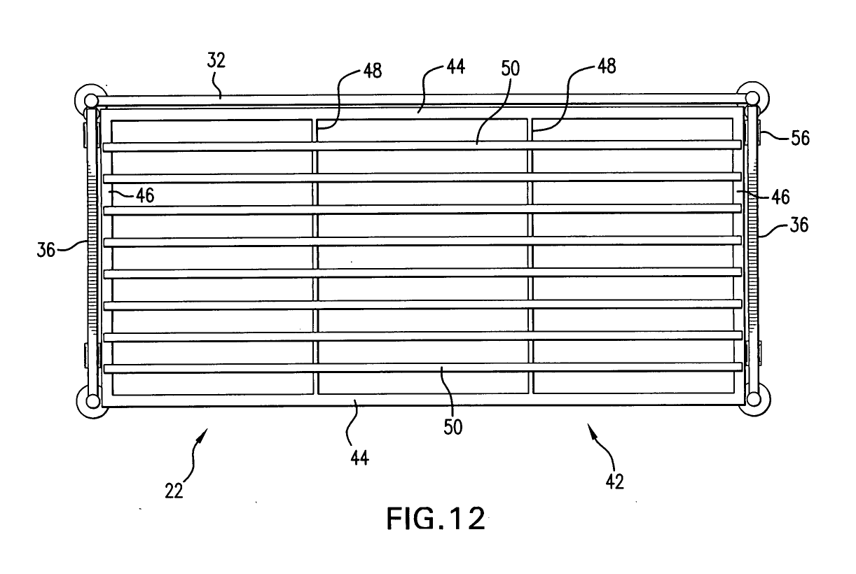

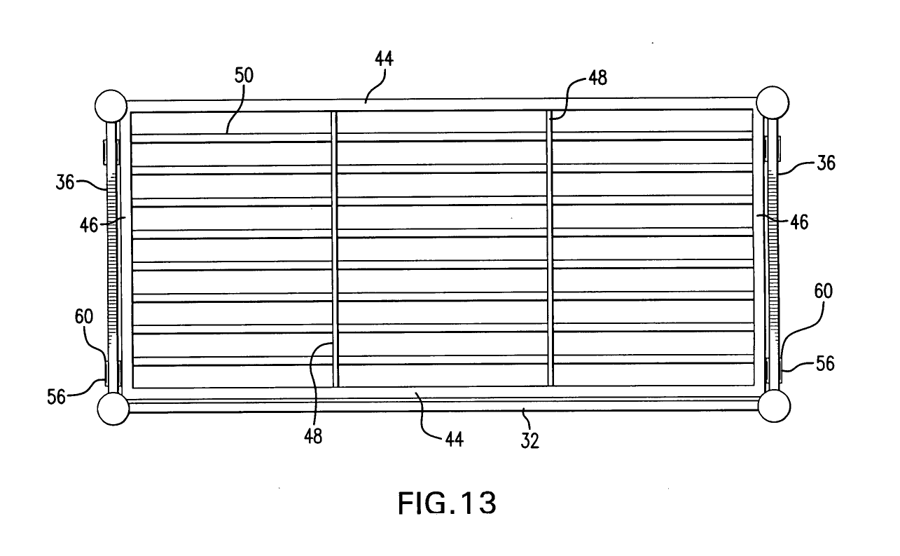

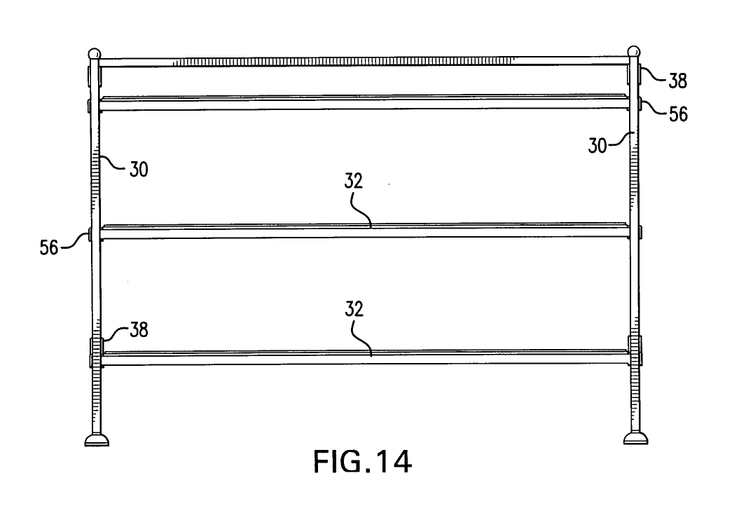

FIGS. 8-14 illustrate another embodiment of the present invention. The rack in FIGS. 8-14 is the same as the rack in FIGS. 1-7, except that the mesh 45 is replaced by a pattern of bars. Therefore, the same numeral designations are used in FIGS. 8-14 to designate the same elements in FIGS. 1-7. In the shelves 22 of FIGS. 8-14, a plurality of connecting bars 48 connect the long sides 44 at about the center of the long sides 44 in spaced-apart manner. A plurality of longitudinal slats 50 extend from the top surfaces of the opposing short sides 46, and over the top of the connecting bars 48. The slats 50 extend from one short side 46 to another short side 46 (i.e., from a left side to a right side) in a manner parallel to the long sides 44 (i.e., the front and rear sides), and the connecting bars 48 extend in a manner parallel to the short sides 46. The rack in FIGS. 8-14 can be folded and deployed in the same manner as described above for the rack in FIGS. 1-7.

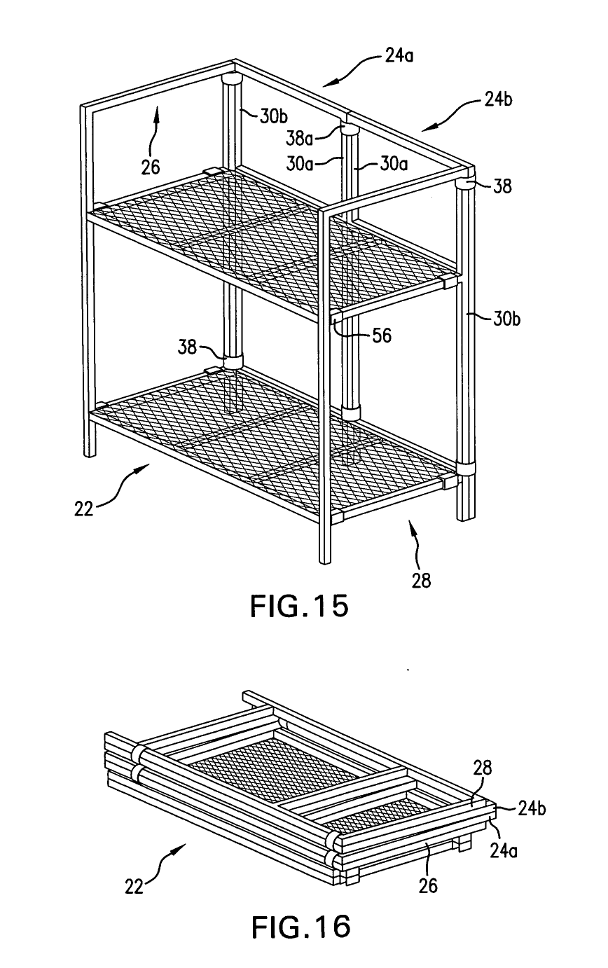

FIGS. 15-16 illustrate yet another embodiment of the present invention. The rack in FIGS. 15-16 is the same as the racks in FIGS. 1-7 and 8-14, except that the rear support 24 now comprises two separate support members 24a and 24b. Therefore, the same numeral designations are used in FIGS. 15-16 to designate the same elements in FIGS. 1-14. The two rear support members 24a, 24b each have an internal vertical bar 30a and an external vertical bar 30b. The internal vertical bars 30a are pivotably connected by collars 38a, with the internal vertical bars 30a received inside the collars 38a so that the support members 24a+24b can pivot thereabout. In addition, as with the earlier embodiments, collars 38 are provided to pivotably connect the external vertical bars 30b of the rear support members 24a, 24b to a corresponding vertical bar 36 of the left support 26 or the right support 28. The vertical bars 30b, 36 are received inside the collar 38a so that the supports 24a+26 or 24b+28 can pivot thereabout.

The rack in FIGS. 15-16 can be folded as follows. First, the shelves 22 are removed. Next, the rear support members 24a, 24b are pivoted or folded towards each other to rest against each other. See FIG. 16. The left support 26 and the right support 28 are then pivoted or folded towards the respective rear support member 24a and 24b. As best seen in FIG. 16, the resulting folded rack has an overall dimension that is half the overall dimension of the racks in FIGS. 1-7 and 8-14. Thus, by allowing the elongate rear support 24 to be folded into a smaller configuration, the resulting rack can be stored or transported using less space.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A rack for holding articles, comprising:
a frame having a first rear support member and a second rear support member, with each support member having a left side and a right side, with the right side of the first rear support member pivotably connected to the left side of the second rear support member;
the frame further including a left support that is pivotably connected to the left side of the first rear support member and a right support that is pivotably connected to the right side of the second rear support member, the left and right supports having a plurality of horizontal bars; and
at least one shelf having a left side and a right side, with a first hooked connector provided on the left side of the shelf and a second hooked connector provided on the right side of the shelf, with the first hooked connector removably connecting the left side of the shelf to a horizontal bar on the left support, and the second hooked connector removably connecting the right side of the shelf to a horizontal bar on the right support.

2. The rack of claim 1, wherein the shelf has an enclosing frame member that has two opposing first sides connected by two opposing second sides to define an interior space, and having a mesh provided in the interior space.

3. The rack of claim 1, wherein the shelf has an enclosing frame member that has two opposing first sides connected by two opposing second sides, at least one connecting bar that connects the first sides, and a plurality of slats, each slat having opposing ends that are connected to the second sides, and wherein each slat is connected to the at least one connecting bar.

4. The rack of claim 1, wherein:
each rear support member has two vertical bars and at least one horizontal bar extending between the vertical bars;
the left support has a plurality of left support horizontal bars extending between two left support vertical bars; and
the right support has a plurality of right support horizontal bars extending between two right support vertical bars.

5. The rack of claim 1, wherein the hooked connector has an inverted U-shape which defines two side walls and a top wall that define a receiving space, with a portion of a horizontal bar received in the receiving space.

6. The rack of claim 5, wherein the hooked connector further includes a lining fitted into the receiving space.

7. The rack of claim 4, wherein one vertical bar of the left support is pivotably connected to one of the vertical bars of the first rear support member and one vertical bar of the right support is pivotably connected to the one of the vertical bars of the second rear support member.

8. The rack of claim 7, further including a first hinged collar that receives the vertical bars of the left support and the first rear support member, and a second hinged collar that receives the vertical bars of the right support and the second rear support member.

9. The rack of claim 8, further including a third hinged collar that receives adjacent vertical bars of the first rear support member and the second rear support member.

10. The rack of claim 1, wherein the first sides are longer than the second sides.

11. A method of folding a rack that holds articles, comprising:
a. providing a rack that has:
a frame having a first rear support member and a second rear support member, with each support member having a left side and a right side, with the right side of the first rear support member pivotably connected to the left side of the second rear support member;
the frame further including a left support that is pivotably connected to the left side of the first rear support member and a right support that is pivotably connected to the right side of the second rear support member, the left and right supports having a plurality of horizontal bars; and
at least one shelf having a left side and a right side, with a first hooked connector provided on the left side of the shelf and a second hooked connector provided on the right side of the shelf, with the first hooked connector removably connecting the left side of the shelf to a horizontal bar on the left support, and the second hooked connector removably connecting the right side of the shelf to a horizontal bar on the right support;
b. removing each shelf by disengaging the hooked connectors from the corresponding horizontal bars;
c. pivoting the rear support members towards each other to rest against each other;
d. pivoting the left support towards the first rear support member; and
e. pivoting the right support towards the second rear support member.
